(19) United States
(12) Patent Application Publication
(10) Pub. No.: US 2012/0066034 A1
(43) Pub. Date: Mar. 15, 2012

(54) ONLINE ACCOUNT TO MOBILE DEVICE LINK

(75) Inventor: Sheffield Nolan, Los Altos, CA (US)

(73) Assignee: APPREDEEM, INC., Mountain View, CA (US)

(21) Appl. No.: 13/226,065

(22) Filed: Sep. 6, 2011

Related U.S. Application Data
(60) Provisional application No. 61/381,884, filed on Sep. 10, 2010.

(51) Int. Cl. G06F 15/16; G06Q 30/00; G06Q 40/00

(52) U.S. Cl. 705/14.1; 709/223; 705/39

(57) ABSTRACT

Systems for and methods of linking an electronic device to an online account using a unique device identifier, and Internet Protocol (IP) address, and online account information such as an email address.

### RELATED APPLICATIONS

This application claims priority under 35 U.S.C. §119(e) of the co-pending U.S. provisional Patent Application Ser. No. 61/381,884, filed Sep. 10, 2010, titled “ONLINE ACCOUNT TO MOBILE DEVICE LINK”, which is hereby incorporated by reference in its entirety.

### FIELD OF THE INVENTION

The present invention relates to using electronic devices for online services. More specifically, the present invention relates to linking an online account to an electronic device having a unique identifier.

### BACKGROUND OF THE INVENTION

Many of the new “smart” electronic devices have a unique identifier (UID) that uniquely identifies the electronic device as distinct from other electronic devices. The UID can be a hash that is generated based on any persistent hardware properties on the device, such as the Media Access Control (MAC) address and/or Mobile Equipment Identifier (MEID). The UID does not need to come from the hardware manufacturer, as a programmer could simply read the MAC address on the device and convert it to a hash string which would uniquely identify the device even after a complete device reset. An electronic device is able to transmit its UID to an online service to identify the electronic device to the online service and, consequently, identify the owner of the electronic device as the user of an online service account. Android smart devices use a universal 128-bit unique identifier (UUID). Apple® products such as the iPhone® and iPod® have a 40-character unique device identifier (UDID). Throughout this document, the terms UUID, UDID, and other unique device identifiers are referred to as a UID. The terms UUID, UDID, and UID are used synonymously and interchangeably, unless otherwise stated, or as one skilled in the art would understand by usage.

To use online services, a user typically generates a user account with a service provider. To streamline interaction with the online service, a user then manually enters the UID of their electronic device so that the user account and the electronic device become linked through the UID. Thereafter, when a user interacts with the service, the user's electronic device is already known to the user account via the UID and the user need not perform a login verification step to use the online service. A UID is a lengthy piece of information that is cumbersome to enter manually. Manual entry of the UID is also prone to data entry errors as the UID is a long, uninterrupted string of characters that have no plain English meaning to aid the user in entering the UID correctly. Currently, there is no automated method of capturing the UID of a user's electronic device and linking the UID to the user's online service account.

### SUMMARY OF THE INVENTION

Embodiments of the presently-claimed invention enable automated capture of the UID of a user's electronic device and linking of the UID to the user's online service account. The UID is captured by a user generating an account, downloading an application assigned to that user, and launching the application within a predetermined verification window of time. The application transmits the UID of the user's device to an Account Server, along with the IP address of the user's electronic device, and an Applicant ID of the downloaded and launched application. The UID is associated with the user's online service account without the user having to enter her device UID manually.

In a first aspect of the invention, a method of linking an online account of a user to an electronic device having a first device identifier that is unique within a database of accounts, and having a second and a third device identifier associated with the account during a predetermined window of time, comprises receiving the first, second, and third device identifiers within the predetermined window of time. In some embodiments, the predetermined window of time is from 1 minute to 14 days. Preferably, the predetermined window of time is 20 minutes. The method further comprises identifying the account of the user using the second and third device identifiers and associating the first unique device identifier with the account, thereby linking the online account with the electronic device. In a preferred embodiment, a combination of the second and third device identifiers is unique with respect to the electronic devices of other users of the method within the predetermined window of time. In some embodiments the first unique identifier is a unique device identifier (UDID) of the electronic device. The first unique identifier can also be a universally unique identifier of the electronic device (UUID). In a preferred embodiment, the second identifier comprises an Internet Protocol (IP) address of the electronic device. The second identifier can also be determined from at least one cell tower or from a global positioning satellite (GPS) coordinate. In a preferred embodiment, the method further comprises providing a software application associated with the account for downloading to the electronic device. The software application transmits the first, second, and third identifiers when the application is launched on the electronic device. Preferably, the third identifier comprises an application identifier of a software application that is transmitted by the electronic device when the application is launched on the electronic device. In some embodiments, the third identifier comprises a token assigned to the account and transmitted by a software application when the application is launched on the electronic device. Preferably, providing a software application having an application identifier comprises providing a link facilitating the downloading of the application to the electronic device. In some embodiments, the method further comprises compensating the user after providing the application to the electronic device. In a preferred embodiment, the method comprises compensating the user after receiving the first identifier of the electronic device. Compensating the user includes crediting a payment to the user and crediting the user's account with points redeemable for goods, services, or both. Preferably, the user's electronic device is one of a cell phone, a smart phone, an iPhone®, an iPod®, an iPad®, a Blackberry®, a personal digital assistant, a tablet computer, a laptop computer, and a personal computer.

In a second aspect of the invention, a method of enabling the linking of an online account in a database of accounts to an electronic device having a first identifier that is unique within the database of accounts, a second identifier, and a software application identifier, comprises receiving the first unique identifier, the second identifier, and the software application identifier of a user's electronic device. The method further comprises transmitting the first unique identifier, the second identifier, and the software application identifier to a verification server that utilizes at least one of the first unique identifier, the second identifier, and the application identifier to associate the first unique identifier with the account, thereby enabling the linking of the online account to the electronic device. In some embodiments, the method further comprises receiving a compensation for the transmitting of the first unique identifier, the second identifier, and the software application identifier. In a preferred embodiment, the method comprises compensating the user of the electronic device occurs after receiving the first unique identifier, the second identifier, and the application identifier of the user's electronic device. In some embodiments the account comprises an account identifier. The account identifier can be the user's email address or the user's login credentials to the online account. In a preferred embodiment, the second identifier is one of an IP address of the electronic device, a OPS coordinate of the electronic device, and a location of the electronic device based upon one or more cell towers.

In a third aspect, a method of linking a user online account having an account identifier to an electronic device of the user, the device having a first unique identifier, a second identifier, and a software application identifier comprises receiving, by a verification server, the first unique identifier, the second identifier, and the application identifier from a third party server. The method further comprises generating and storing, by the verification server, a verification record comprising the first unique identifier, the second identifier, and the application identifier, receiving, by the verification server, the account identifier, the second identifier, and the application identifier, and associating the first unique identifier with the account, thereby linking the online account to the electronic device.

In a fourth aspect, a device comprises a computer-readable memory programmed with instructions implementing any of the above methods.

### TERMINOLOGY

Throughout the disclosure, the following definitions are used, unless otherwise specified, or as understood by a person of skill in the art. An electronic device is a device having a display screen, a processor or controller, a read/write memory for storing data and executable instructions, an input interface, and a communications module. The electronic device is capable of connecting to the Internet, preferably via WiFi, Wireless Application Protocol (WAP), 3G or 4G network communications protocols, or other mobile communications protocol.

The electronic device preferably has a first unique identifier, such as Apple's® unique device identifier (UDID), the telephone number of the device, or a universally unique identifier (UUID). Other unique identifiers can include a serial number of the BIOS chip within the device, and a manufacturer name and model number, or any combination these. Further, the UID can be a hash generated based on any persistent hardware properties on the device, such as the Media Access Control (MAC) address and/or Mobile Equipment Identifier (MEID). The UID does not need to come from the hardware manufacturer, as a programmer could simply read the MAC address on the device and convert it to a hash string which would uniquely identify the device even after a complete device reset. For brevity, throughout this document the term UID refers to any unique identifier of the electronic device, not limited to Apple's® UDID. The UID is unique with respect to the UIDs of other devices stored in account records on an Account Server, as described below.

An application is a software program for running upon an electronic device. The application has a unique identifier termed an Application ID. The Application ID is unique with respect to the Application ID of other software applications available for assignment to a user for downloading and launching by the user. An application running on the electronic device is capable of transmitting the Application ID and UID of the electronic device to a computing device such as an Account Server, a Verification Server, or a Third Party Server described below. A device receiving the transmission of the Application ID and the UID is capable of extracting a second identifier from the transmission such as an Internet Protocol (IP) address, a coordinate of at least one cell tower, or a global positioning system (GPS) coordinate. For brevity, throughout this document the IP Address is used and refers to any identifier that is sparse in relation to the anticipated number of users having the identifier and the number of Application IDs available for assignment to a user within a given verification window time of a known duration. See the explanation of verification window of time, below.

An Account Server is a server upon which a user generates an online account. In a preferred embodiment, during account generation, the Account Server assigns an application having an Application ID to a user for downloading and launching within a verification window of time. When the user generates the online account, a verification record is generated comprising data fields for the user's electronic device IP address and Application ID. A Verification Server is a server that generates, stores, and purges verification records and implements account linking verification logic. A Third Party Server is a server that receives UIDs, Application IDs and IP addresses from users' electronic devices for forwarding to a Verification Server. The Account Server, the Verification Server, and the Third Party Server are all computer hardware comprising a read/write storage, a processor, a memory, a display, a keyboard, a network interface, and other well-known computer server components. A single computing system can comprise the Account Server and the Verification Server. In such case, transmission between the Account Server and the Verification Server can be memory-to-memory transfers, messages across a system bus, inter-process events, and other methods of inter-process communications known in the art. The user's electronic device, the Account Server, the Verification Server, and the Third Party Server all communicate via a network. In some embodiments, the network is a WiFi network. The network can be any known network standard including Ethernet, USB, Token Ring, Cellular 3G, Cellular 4G, I²C, RS485 serial, RS232 serial, or other inter-device communication medium.

A predetermined window of time is a period of time during which a user completes a link between her online account and her electronic device. After the expiration of the predetermined window of time, the verification record will be purged, and later attempts to verify the account by launching the downloaded application will fail because the verification record has been purged. The verification window of time is in the range from 1 minute to 14 days. Preferably the verification window of time is 20 minutes. The length of the predetermined window of time is determined based upon several factors including the anticipated number of users that will utilize the methods described herein during the window of time, the number of users anticipated to be utilizing a second identifier, such as an IP Address discussed above, and the numerosity of the third identifier, such as the number of software applications having an Application ID that are available for assignment to a user. During the predetermined window of time, a verification record is generated for a user attempting to link her device and her online account. The verification record comprises a reference to a user's account information, the second device identifier (e.g. IP Address) and the third device identifier (e.g. Application ID). A combination of the second and third identifiers is unique within the predetermined period of time. Thus, the greater the number of users that have the same second identifier, e.g., the IP address, the greater the numerosity of the third identifier, e.g. Application IDs, for a specified window of time so that the combination of the second and third identifiers is unique within the verification records during the window. In some embodiments, a generic account generation software application is downloaded and launched by the user with a token assigned to the application for transmission as the third identifier, instead of the Account ID. The third identifier can then be made as numerous as needed to ensure that a combination of the second and third identifiers is unique with the verification records during the verification window of time. Accordingly, the verification window can be made as long as needed by tailoring the size of the token. In embodiments where the verification record is generated at the time that the user generates an online account, it is desirable to set the duration of the predetermined window of time to allow the user a practical amount of time, e.g. 20 minutes, to complete the linking process by downloading and launching the software application assigned to the user during the account generation process. Alternatively, the predetermined window of time can be made shorter by generating the verification record at the time of downloading the application such that a user may reasonably launch the application within moments, or only a few minutes, of downloading the application.

As an example, a wireless hot spot having an IP address is a Starbucks® coffee shop seating 40 people. At rush hour, the Starbucks® might serve 1,000 customers in several hours. If 500 applications are available for assignment and download to a user linking her account to her electronic device, the combination of the IP address and an application ID would be unique across the anticipated users across a window of time spanning several hours even if only half of the people at the coffee shop simultaneously attempt to link an account to a device.

### BRIEF DESCRIPTION OF THE DRAWINGS

FIG. 1A illustrates a system for and method of linking an online account to an electronic device having a first unique identifier according to some embodiments.

FIG. 1B illustrates a system for and method of linking an online account to an electronic device according to some embodiments.

FIG. 2 illustrates a method of linking an online account to an electronic device having a first unique identifier (UID) according to some embodiments.

FIG. 3A illustrates a method of determining whether an account is verified within a verification time window according to some embodiments.

FIG. 3B illustrates a method of determining whether an account is verified within a verification time window according to some embodiments.

FIG. 4A illustrates fields of a set of verification records for linking online accounts to user electronic devices according to some embodiments.

FIG. 4B illustrates fields of a set of verification records for linking online accounts to user electronic devices according to some embodiments.

### DETAILED DESCRIPTION OF THE DRAWINGS

The following figures illustrate features of specific embodiments of the presently-claimed invention. Throughout the figures identical labels refer to identical or similar elements. The following embodiments are intended to illustrate the features of the presently-claimed invention. The invention is not limited to only the disclosed embodiments.

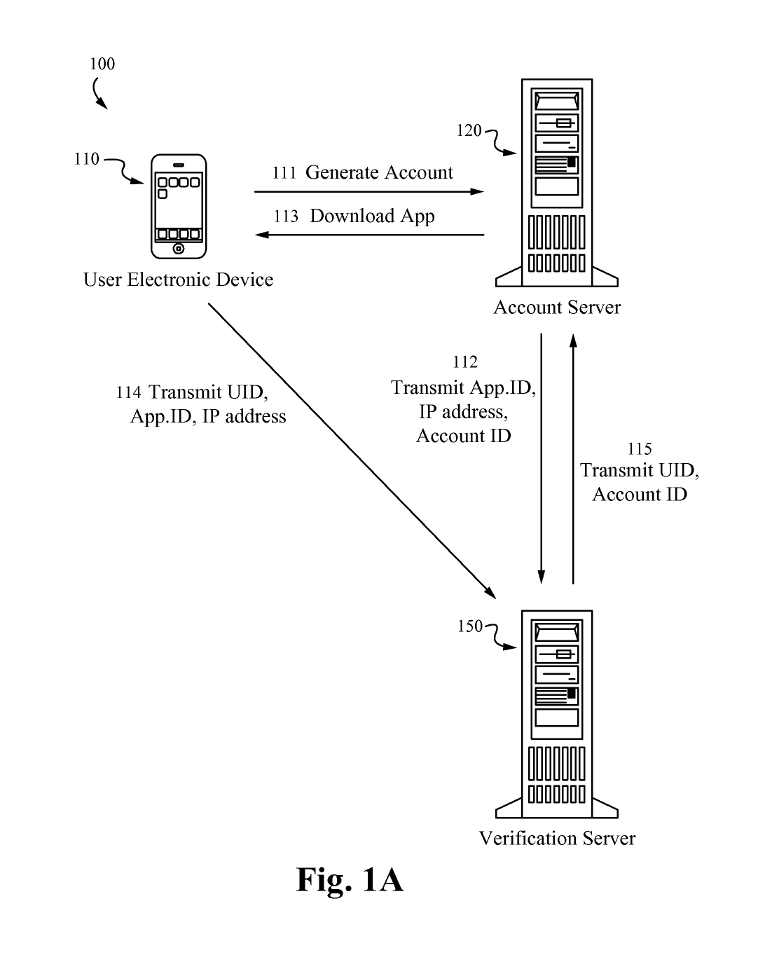

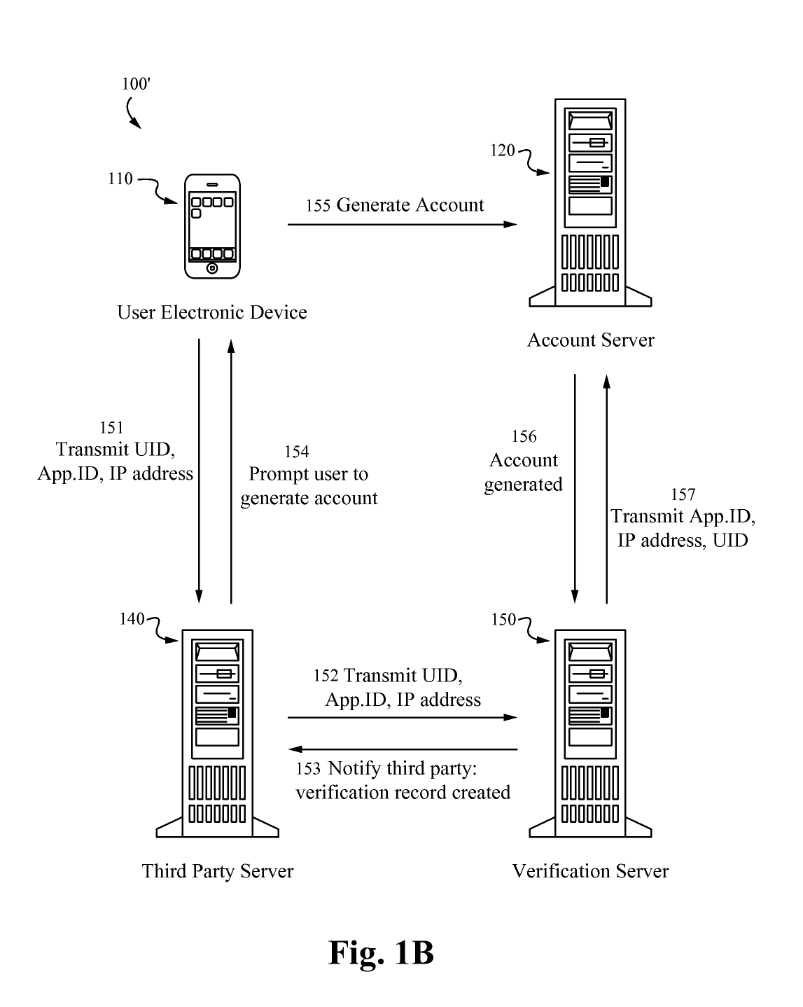

FIG. 1A illustrates a preferred embodiment of a system 100 for and method of linking an online account to an electronic device 110 having a first unique identifier (UID) according to some embodiments. A user wants to use her electronic device 110 to obtain online services via an online account. Using the electronic device 110, at step 111 the user generates an online account having an Account ID on an Account Server 120. The Account Server 120 captures the user's IP address when the user generates the account. The Account Server 120 also assigns an application having an Application ID for the user to download and launch. At step 112, the Account Server 120 transmits the Application ID of the application assigned to the user, the IP address of the user's electronic device 110, and the Account ID of the user's account to a Verification Server 150. The combination of the IP address and the Application ID is unique within the verification records on the Verification Server 150 during a verification window of time. The Verification Server 150 generates and stores an account verification record comprising the Account ID, IP address and Application ID. The Verification Server 150 also sets a verification time window for the user to perform a verification step comprising downloading 113 and launching the assigned application. When the application is launched on the user's electronic device 110, at step 114, the application reads the UID of the electronic device 110 and transmits the UID, Application ID, and IP address of the electronic device 110 to the Verification Server 150. The Verification Server 150 looks up the verification record having the IP address and Application ID received from the user device 110 and extracts the Account ID from the verification record. At step 115, the Verification Server 150 transmits the UID and Account ID to the Account Server 120. The Account Server 120 looks up the user account information using the Account ID, then stores the UID of the user's electronic device 110 with the user account, thereby linking the electronic device 110 to the user account.

FIG. 1B illustrates a system 100′ for and method of linking an online account to the electronic device 110 according to some embodiments. In the system 100′, a Third Party Server 140 collects the UID from an application running on the user device 110. The third party is typically an author or publisher of applications having an Application ID and capable of reading and transmitting the UID of an electronic device 110 to the Verification Server 150. Alternatively, the third party can be an agent that harvests UIDs from known applications and forwards a UID, Application ID and IP address of a user device, e.g., the user electronic device 110, to the Verification Server 150. An application having and Application ID, running on the electronic device 110, reads the UID from the electronic device 110.

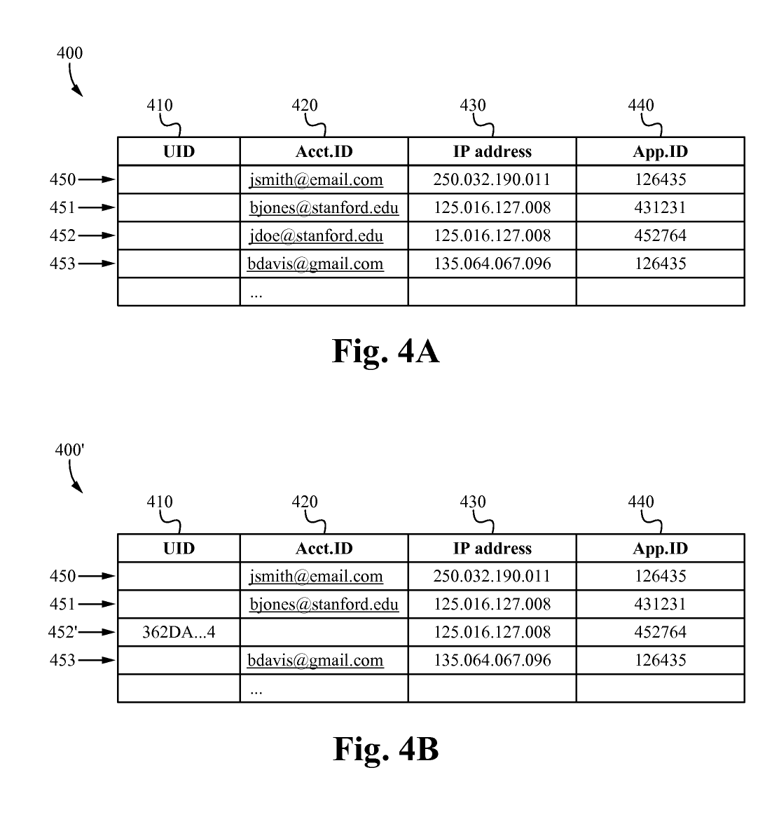

At step 151, the application transmits the UID, the Application ID of the application, and the IP address of the electronic device 110 to the Third Party Server 140. In the step 152, the Third Party Server 140 then transmits the UID, Application ID and the IP address to the Verification Server 150. The Verification Server 150 determines in the verification window of time whether there is a verification record having the same Application ID and IP address. If there is no verification record within the verification window having the same Application ID and IP address, a verification record is generated that stores the UID, Application ID and IP address of the device. FIG. 4B, discussed below, illustrates the verification record fields with an example of a verification record 452′ generated from information obtained from the Third Party Server 140. At step 153, the Verification Server 150 notifies the Third Party Server 140 that a verification record has been generated for the user's online account comprising a UID, Application ID, and IP address transmitted to the Verification Server 150 in step 152. Preferably, the Verification Server 150 also notifies the Third Party Server 140 of the verification window time at step 153. In step 154, the Third Party Server 150 then prompts the user to generate an account within the verification window time. Alternatively to step 154, the application on the user device 110 sets a predetermined verification window the same as, or less than, the verification window used by the Verification Server 150 and informs the user to generate the account in step 155 within the predetermined verification window of time.

During the account generation process, the user enters the Application ID of the application that prompted her to generate an account. Alternatively, the prompt in step 154 for the user to generate an account contains a link to the Account Server 120, the link containing the Application ID of the application that prompted the user to generate the account so that the Application ID is passed to the Account Server 120 during the account generation step 155 without the user having to enter the Application ID manually. In step 156, the Account Server 120 transmits the newly generated Account ID, the received Application ID and the IP address of the user's electronic device 110 to the Verification Server 150 for verification within the verification time window. The Verification Server 150 then looks up the verification record corresponding to the unique combination of the user's IP address and Application ID, retrieves the UID from the verification record, and transmits the Account ID and UID to the Account Server 120, thereby linking the online account to the electronic device 110.

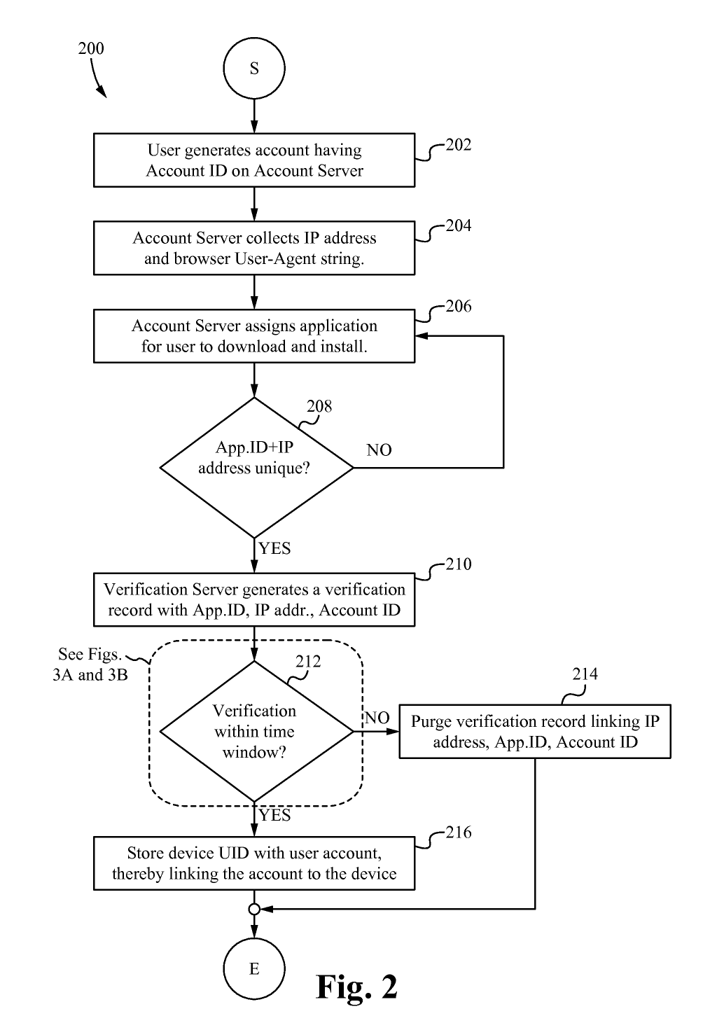

FIG. 2 shows the steps of a method 200 of linking an online account to an electronic device having a first unique identifier (UID), according to some embodiments. At a step 202, a user generates an account on a Account Server using the electronic device to be linked to the account. The account can comprise information including the first and last name of the user, an email address, a street address, city, state, and zip code, a telephone number, manufacturer and model number of the user's electronic device, a login and a password combination, and other information as is known in the art of online account generation. At least one piece of unique account information serves as a unique account identifier, termed Account ID. The Account ID can alternatively be a unique account identifier generated by the account generation system rather than a piece of information entered by the user. At step 204, the Account Server acquires the IP address of the user's electronic device as the user generates the online account. Other information from the user's account generation session, such as a User Agent string from the user's browser, can also be acquired and stored. A User Agent running on the user's electronic device 110 can transmit to the Account Server information about the User Agent such as the User Agent's application type, software vendor, software revision level, or the electronic device 110 operating system, as is known in the art. At step 206, the Account Server assigns an application to the user for downloading and launching in a later account verification step.

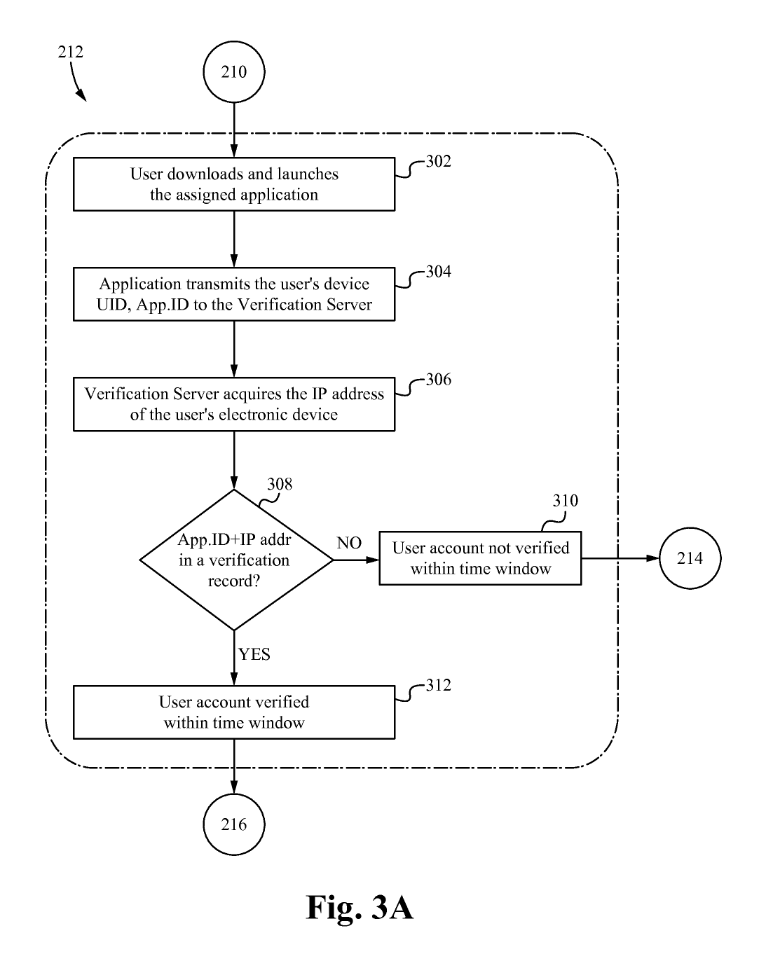

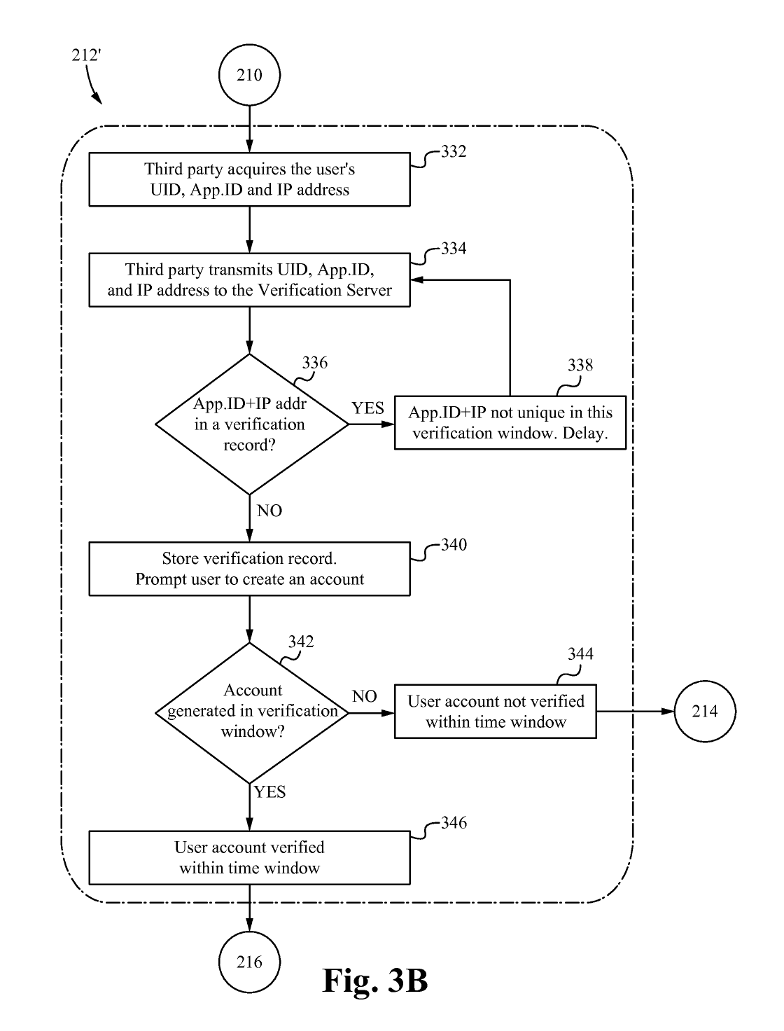

An application has a unique Application ID. In some embodiments, the Application ID is unique with respect to the software applications available to the Account Server for assignment to a user and for subsequent downloading and launching by the user. The combination of the IP address and Application ID is unique within the verification records on the Verification Server within the verification window of time. At step 208, the Account Server queries the Verification Server to determine whether the combination of the Application ID and the IP address of the user is unique within the Verification Server records that are pending verification within the verification time window. If the combined Application ID and IP address is not unique within the pending verification records, then at step 206 a different application having a different Application ID is assigned to the user. If the combined Application ID and IP address is unique, then the process proceeds to step 210 in which the Verification Server generates and stores a verification record comprising the Account ID, the IP address, the Application ID, and a blank field for receiving the UID of the user's device, as shown in FIGS. 4A and 4B, described below. Also at step 210, a verification time window is set during which the user completes an account verification process, described below. The method then proceeds to step 212 where it is determined whether the account is verified. In FIGS. 3A and 3B, two variations of the account verification step 212 are shown. At step 212, if the account verification was performed within the verification window of time, then the method proceeds to step 216 where the UID of the user's electronic device is stored with the user's online account information. Otherwise the method proceeds to step 214 where the verification record generated in step 210 is purged. From steps 214 and 216, the method ends at a node labeled “E”.

FIG. 3A illustrates a preferred embodiment of the step 212 of FIG. 2 of verifying the linking of a user account to an electronic device of a user during a verification window of time. In step 302, a user downloads and launches the application assigned to her in FIG. 2, step 206. At step 304, the launched application transmits the UID of the user's electronic device and the Application ID associated with the application to a Verification Server. At step 306 the Verification Server acquires the IP address from the transmission by the user's electronic device. At step 308, the Verification Server determines whether there is a verification record having the Application ID and IP address transmitted by the user's electronic device. If the Verification Server finds a record having the Application ID and IP address transmitted by the user's electronic device, then the method proceeds to step 312. At step 312, the user account is verified within the verification time window and the method 212 returns to step 216 of FIG. 2. Otherwise, at step 310 it is determined that the user account is not verified within the verification time window and the method proceeds to step 214 of FIG. 2.

FIG. 3B illustrates another method of verifying the linking of a user account 212′ to an electronic device of the user during a verification window of time, corresponding to step 212 of FIG. 2, titled “Verification within time window?”. In this embodiment, at step 332, a Third Party Server acquires the user device's UID, the Application ID, and IP address. In the step 334, the Third Party Server transmits the UID, Application ID, and IP address of the user's electronic device to a Verification Server. At step 336, the Verification Server determines whether the combined Application ID and IP address is found in a verification record during a verification window of time. If the combined Application ID and IP address is present in a verification record, then at step 338 it is determined that the data transmitted from the third party is not unique in this verification window, therefore a verification record for the third party data cannot yet be generated. In some embodiments, the Verification Server can delay a period of time, and retry the verification step. In other embodiments, the Verification Server can transmit a message to the Third Party Server that the combination of the Application ID and IP address is not unique within the verification time window, and the Third Party Server can delay for a period of time, such as the verification window of time, then retransmit the UID, Application ID, and IP address to the Verification Server according to step 334. If in the step 336 it is determined that the combination of the Application ID and IP address is unique within the verification records, then at step 340 the Verification Server stores a verification record comprising the UID, IP Address and the Application ID, and notifies the Third Party Server to prompt the user to generate a user account. In some embodiments, the Verification Server notifies the Third Party Server of the duration of the verification window of time (not shown). In other embodiments, the Third Party Server assumes a verification window of time and notifies the user of the duration of the verification of time when prompting the user to generate an account in step 340. In other embodiments, a verification window of time is predetermined in the software application running on the user's device and that verification time window is presumed to be less than the verification time window used by the Verification Server. In step 342, if the user generates an account within the verification time window, the method proceeds to step 346 and it is determined that the account was verified with the verification time window, and the method returns to FIG. 2 at step 216. Otherwise at step 344 it is determined that the account was not verified with the verification time window, and the method returns to FIG. 2 at step 214.

FIG. 4A shows a set of verification records 400 in a preferred embodiment. In the preferred embodiment, a user generates a user account as described in FIGS. 1A and 2. The user account comprises an Account ID 420. Field 410 of an example verification record 450 is a first unique identifier, the UID of the user's electronic device. In a preferred embodiment, the UID field 410 is initially blank when the verification record 450 is generated. The UID will be acquired during a later verification step. The verification record 450 further comprises a second identifier 430 that need not be unique, but is preferably sparse with respect to the domain of users utilizing the identifier within a verification window of time, as described above. In a preferred embodiment, the second identifier 430 is the IP address of the user's electronic device to which the user account will be linked. The verification record 450 also comprises an Application ID 440. The Application ID 440 is a unique identifier of a software application that, when the application is launched by the user, transmits the UID 410 of the user's electronic device to a Verification Server. The combination of the second identifier (IP address) 430 and the Application ID 440 is unique during a verification window of time. Four (4) example verification records, 450, 451, 452, and 453 are shown in FIG. 4A. Two users may be, for example, located in the same coffee shop, dorm room mates, or co-workers, and therefore have the same IP address 430 during the verification window as shown in example records 451 and 452. The example records 451 and 452 have different Application IDs 440, therefore the combination of the IP address 430 and the Application ID 440 is unique with respect to records 451 and 452, as well as the other verification records in the set of verification records 400 during the verification time window. Similarly, verification records 450 and 453 have the same Application ID 440, but they have different IP addresses 430, therefore the combination of the IP address 430 and the Application ID 440 is unique within the verification window of time.

FIG. 4B shows another set of verification records 400′ in an alternate embodiment. Referring to verification record 452′, in this embodiment, a third party collects verification information comprising the UID 410, IP address 430, and Application ID 440 of a user's electronic device for generating the verification record 452′. The third party forwards the verification information to the Verification Server. Since the UID 410 is already present in the verification information, the missing piece of information to link a user account to the user's electronic device is a user Account ID 420. The Verification Server looks up the UID 410 of the record 452′ to determine whether the user of this electronic device already has an account. If so, the third party is notified as such and a verification record is not generated. If there is no user account corresponding to the UID 410, then a check is made as to whether the combination of the IP address 430 and the Application ID 440 in the verification information is unique within the verification records on the Verification Server within the verification time window. If not, then the third party is notified as such and no verification record is generated. During the verification window of time, one or more users can complete the account generating process and the account verification process. After account verification is completed within the verification window of time, the verification record 452′ corresponding to the user's verification information is purged so that the unique combination of the IP address 430 and the Application ID 440 in the purged verification record 452′ is available for use by another user. In some embodiments, the Verification Server may delay for a period of time, either predetermined or random, and retry the check to determine whether the combination of the IP address 430 and the Application ID 440 is unique within the verification records during the verification time window. Alternatively, the Verification Server can notify the third party that the combined IP address 430 and the Application ID 440 is not unique within the verification records on the Verification Server during the verification time window and the third party can retransmit the UID 410, IP address 430, and the Application ID 440 after delaying for a period of time, either random or predetermined. If the combination of the IP address 430 and the Application ID 440 for the record 452′ is unique within the verification records on the Verification Server during the verification time window of time, then the verification record 452′ is stored on the Verification Server, and a notification is sent to the third party as to the duration of the verification time window. It is presumed that the third party can notify the user of the electronic device that the account server is awaiting an account generation by the user during the verification window of time. A user generates a user account as described in FIGS. 1B and 2.

In operation, a method of linking an online account to a user's electronic device begins with a user generating an online account having an Account ID on an Account Server. The Account Server assigns an application to a user, the application having an Application ID. The Account Server passes the Account ID, Application ID, and the IP Address of the user's electronic device to a Verification Server. The Verification Server generates a verification record using the IP address combined with the Application ID as a unique key. The user downloads the application assigned to her and launches the application within a verification time window. The application transmits the user's electronic device UID, IP Address, and Application to the Verification Server within the verification window of time. The Verification Server looks up the verification record corresponding to the combined Application ID and IP address, obtains the Account ID, and transmits the UID and Account ID to the Account Server. The Account Server stores the UID with the user account information, thereby linking the user account with the user's electronic device.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications are able to be made to the embodiments chosen for illustration without departing from the spirit and scope of the invention as defined by the appended claims.

What is claimed is:

1. A method of linking an online account of a user to an electronic device having a first device identifier that is unique within a database of accounts, and having a second and a third device identifier associated with the account during a predetermined window of time, the method comprising:
receiving the first, second, and third device identifiers within a predetermined window of time;
identifying the account of the user using the second and third device identifiers; and
associating the first unique device identifier with the account,
thereby linking the online account with the electronic device.

2. The method of claim 1, wherein a combination of the second and third device identifiers is unique with respect to the electronic devices of other users of the method within the predetermined window of time.

3. The method of claim 1, wherein the first identifier is a unique device identifier (UDID) of the electronic device.

4. The method of claim 1, wherein the first identifier comprises a unique universal identifier (UUID) of the electronic device.

5. The method of claim 1, wherein the second identifier comprises an Internet Protocol (IP) address.

6. The method of claim 1, wherein the second identifier is determined from at least one cell tower.

7. The method of claim 1, wherein the second identifier comprises a global positioning satellite (GPS) coordinate.

8. The method of claim 1, further comprising providing a software application associated with the account for downloading to the electronic device, wherein the software application transmits the third identifier when the application is launched on the electronic device.

9. The method of claim 1, wherein the third identifier comprises an application identifier of a software application that is transmitted when the application is launched on the electronic device.

10. The method of claim 1, wherein the third identifier comprises a token assigned to the account and transmitted by a software application when the application is launched on the electronic device.

11. The method of claim 8, wherein providing a software application having an application identifier comprises providing a link facilitating the downloading of the application to the electronic device.

12. The method of claim 8, further comprising compensating the user after providing the application to the electronic device.

13. The method of claim 1, further comprising compensating the user after receiving the first identifier of the electronic device.

14. The method of claim 13, wherein compensating the user comprises crediting a payment to the user.

15. The method of claim 13, wherein compensating the user comprises crediting the user's account with points redeemable for goods, services, or both.

16. The method of claim 1, wherein the electronic device is one of: a cell phone, a smart phone, an iPhone®, an iPod®, an iPad®, a Blackberry®, a personal digital assistant, a tablet computer, a laptop computer, and a personal computer.

17. The method of claim 1, wherein the predetermined window of time is between 1 minute and 14 days.

18. The method of claim 17, wherein the predetermined window of time is 20 minutes.

19. A method of enabling the linking of an online account in a database of accounts to an electronic device having a first identifier that is unique within the database of accounts, a second identifier, and a software application identifier, the method comprising:
receiving the first unique identifier, the second identifier, and the software application identifier of a user's electronic device; and
transmitting the first unique identifier, the second identifier, and the software application identifier to a verification server configured to utilize at least one of the first unique identifier, the second identifier and the application identifier to link the electronic device with the account.

20. The method of claim 19, further comprising:
receiving a compensation for the transmitting of the first unique identifier, the second identifier, and the software application identifier.

21. The method of claim 19, further comprising:
compensating the user of the electronic device after receiving the first unique identifier, the second identifier, and the application identifier of the user's electronic device.

22. The method of claim 19, wherein the second identifier is one of an IP address of the electronic device, a GPS coordinate of the electronic device, and a location of the electronic device based upon one or more cell towers.

23. A method of linking a user online account having an account identifier to an electronic device of the user, the device having a first unique identifier, a second identifier, and a software application identifier, the method comprising:
a. receiving, by a verification server, the first unique identifier, the second identifier, and the application identifier from a third party server;
b. generating and storing, by the verification server, a verification record comprising the first unique identifier, the second identifier, and the application identifier;
c. receiving, by the verification server, the account identifier, the second identifier, and the application identifier, and;
d. associating the first unique identifier with the account,
thereby linking the online account to the electronic device.

24. A device comprising a computer-readable memory programmed with instructions implementing the method of claim 1.

25. A device comprising a computer-readable memory programmed with instructions implementing the method of claim 19.

26. A device comprising a computer-readable memory programmed with instructions implementing the method of claim 23.
